(19) United States
(12) Patent Application Publication
(10) Pub. No.: US 2024/0234695 A9
(43) Pub. Date: Jul. 11, 2024

(54) LAYERED ELECTROACTIVE MATERIAL AND METHODS OF FORMING THE SAME

(71) Applicant: GM GLOBAL TECHNOLOGY OPERATIONS LLC, Detroit, MI (US)

(72) Inventors: Jeffrey David CAIN, Royal Oak, MI (US); Nicholas Paul William PIECZONKA, Windsor (CA); Anil K. Sachdev, Rochester Hills, MI (US)

(73) Assignee: GM GLOBAL TECHNOLOGY OPERATIONS LLC, Detroit, MI (US)

(21) Appl. No.: 17/971,301

(22) Filed: Oct. 21, 2022

(51) Int. Cl. H01M 4/36; H01M 4/04; H01M 4/58

(52) U.S. Cl. CPC H01M 4/366; H01M 4/0459; H01M 4/58; H01M 2004/021

(57) ABSTRACT

An electroactive material for an electrochemical cell that cycles lithium ions is provided. The electroactive material includes a plurality of atomic layers and a plurality of cations disposed between the atomic layers. The plurality of atomic layers includes an atom selected from the group consisting of: silicon, germanium, boron, and combinations thereof. The plurality of cations is selected from the group consisting of: calcium, magnesium, zinc, copper, nickel, potassium, sodium, and combinations thereof. A ratio of the cations to atoms that define the atomic layer may be less than about 1:2.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12 V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. The negative electrode typically includes a lithium insertion material or an alloy host material. For example, typical electroactive materials for forming an anode include graphite and other forms of carbon, silicon and silicon oxide, and/or tin and tin alloys. Certain anode materials have particular advantages. While graphite having a theoretical specific capacity of 372 mAh·g⁻¹ is most widely used in lithium-ion batteries, anode materials with high specific capacity, for example specific capacities ranging about 900 mAh·g⁻¹ to about 4,200 mAh·g⁻¹, are of growing interest. For example, silicon has the highest known theoretical capacity for lithium (e.g., about 4,200 mAh·g⁻¹), making it an appealing material for rechargeable lithium-ion batteries. Such materials, however, are often susceptible to huge volume expansion (e.g., about 300% for silicon as compared to about 10% for graphite) during lithiation and delithiation, which can lead to particle pulverization, loss of electrical contact, and unstable solid-electrolyte interface (SEI) formation, causing electrode collapse and capacity fading. Further, silicon-containing electroactive materials often have low intrinsic electrical conductivity (e.g., about 10⁻⁵ S/cm) at room temperature (e.g., greater than or equal to about 22° C. to less than or equal to about 23° C.), which is much lower than the intrinsic electrical conductivity of carbon (e.g., greater than or equal to about 10 S/cm to less than or equal to about 10⁴ S/cm at the same temperature. The low intrinsic electrical conductivity of silicon may can cause deterioration of rate performance for the lithium-ion battery, hindering practical high-power applications. Accordingly, it would be desirable to develop improved materials, and methods of making and using the same, that can address these challenges.

### SUMMARY

This section provides a general summary of the disclosure, and is not a comprehensive disclosure of its full scope or all of its features.

The present disclosure relates to a layered electroactive material (for example, a two-dimensional, layered silicon allotrope) and to methods of forming and using the same.

In various aspects, the present disclosure provides an electroactive material for an electrochemical cell that cycles lithium ions. The electroactive material may include a plurality of atomic layers and a plurality of cations disposed between the atomic layers. The plurality of atomic layers may include an atom selected from the group consisting of: silicon, germanium, boron, and combinations thereof. A ratio of the cations to atoms that define the atomic layer may be less than about 1:2.

In one aspect, the electroactive material may be represented by X¹_{(1-y)}X²₂, where X¹ may represent the cation, X² may represent the atom that defines the atomic layers, and y may be less than 1.

In one aspect, the plurality of cations may be selected from the group consisting of: calcium, magnesium, zinc, copper, nickel, potassium, sodium, and combinations thereof.

In one aspect, the plurality of cations may be a first plurality of cations, and the electroactive material may further include a second plurality of cations. The second plurality of cations may include lithium ions.

In one aspect, the plurality of cations may be a first plurality of cations, and the electroactive material may further include a second plurality of cations. The first plurality of cations may include calcium. The second plurality of cations may be selected from the group consisting of: magnesium, zinc, copper, nickel, potassium, sodium, and combinations thereof.

In one aspect, the electroactive material may be in the form of a plurality of electroactive particles having an average diameter greater than or equal to about 100 nanometers to less than or equal to about 50 micrometers.

In various aspects, the present disclosure provides a method for forming a layered negative electrode material. The method may include removing cations from a precursor material to form the layered negative electrode material that includes a plurality of atomic layers including atoms and ions disposed between the atomic layers. A ratio of the ions to atoms defining the atomic layer may be less than 1:2.

In one aspect, the cations in the precursor material may include a first portion of cations and a second portion of cations and the removing may include removing the first portion of the cations, where the second portion remains in the precursor material and defines the ions.

In one aspect, the removing of the cations may include an electrochemical extraction process or a chemical extraction process.

In one aspect, the precursor material may be represented by M¹ₓM²₂, where M¹ may be selected from the group consisting of: calcium, magnesium, zinc, copper, nickel, potassium, sodium, and combinations thereof, M² may be selected from the group consisting of: silicon, germanium, boron, and combinations thereof, and x may be less than 1.

In one aspect, the removing of the cations may include removing substantially all of the cations in the precursor material, and the may method further include re-intercalating secondary cations to form the ions disposed between the plurality of atomic layers.

In one aspect, the precursor material may include CaX₂, where X may be selected from the group consisting of: silicon, germanium, boron, and combinations thereof, and the secondary cations may be selected from the group consisting of: magnesium, zinc, copper, nickel, potassium, sodium, and combinations thereof.

In one aspect, the re-intercalating may include a chemical process or electrochemical process.

In one aspect, the removing of the cations from the precursor material may include exchanging the cations for secondary cations using an ion exchange process to form a modified precursor material that includes a first portion of secondary cations and a second portion of secondary cations, and de-intercalating the first portion of the secondary cations from the modified precursor material, where the second portion of the secondary cations defines the ions disposed between the atomic layers.

In one aspect, the precursor material may include CaX₂, where X may be selected from the group consisting of: silicon, germanium, boron, and combinations thereof, and the secondary cations may be selected from the group consisting of: magnesium, zinc, copper, nickel, potassium, sodium, and combinations thereof.

In one aspect, the de-intercalating of the first portion of the secondary cations may include an electrochemical extraction process or a chemical extraction process.

In one aspect, the precursor material may be disposed on or near one or more surfaces of a current collector.

In various aspects, the present disclosure provides an electrochemical cell that cycles lithium ions. The electrochemical cell may include a first electrode, a second electrode, and a separating layer disposed between the first electrode and the second electrode. The first electrode may have a first polarity and may include a first electroactive material. The second electrode may have a second polarity that is different from the first polarity and may include a second electroactive material. The second electroactive material may include a plurality of atomic layers that include an atom that may be selected from the group consisting of: silicon, germanium, boron, and combinations thereof, and a plurality of cations disposed between the atomic layers. The plurality of cations may be selected from the group consisting of: calcium, magnesium, zinc, copper, nickel, potassium, sodium, and combinations thereof. A ratio of the cations to atoms defining the atomic layer may be less than 1:2.

In one aspect, the plurality of cations may be a first plurality of cations, and the second electroactive material may further include a second plurality of cations. The second plurality of cations may include lithium ions.

In one aspect, the plurality of cations may be a first plurality of cations, and the second electroactive material may further include a second plurality of cations. The first plurality of cations may include calcium. The second plurality of cations may include ions selected from the group consisting of: magnesium, zinc, copper, nickel, potassium, sodium, and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell including a layered electroactive material in accordance with various aspects of the present disclosure;

FIG. 2 is a flowchart illustrating an example partial de-intercalation method for preparing a layered electroactive material that includes interplanar atoms in accordance with various aspects of the present disclosure;

FIG. 3 is an illustration of an example electrochemical chemical process for partial de-intercalation of a precursor material to form a layered electroactive material that includes interplanar atoms in accordance with various aspects of the present disclosure;

FIG. 4 is a flowchart illustrating an example full deintercalation and partial re-intercalation method for preparing a layered electroactive material that includes interplanar atoms in accordance with various aspects of the present disclosure;

FIG. 5 is an illustration of an example electrochemical chemical process for partial re-intercalation of secondary cations into a layered electroactive material to form a layered electroactive material that includes interplanar atoms in accordance with various aspects of the present disclosure; and

FIG. 6 is a flowchart illustrating an example ion exchange and partial de-intercalation method for preparing a layered electroactive material that includes interplanar atoms in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including layered electroactive materials and to methods of using and forming the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

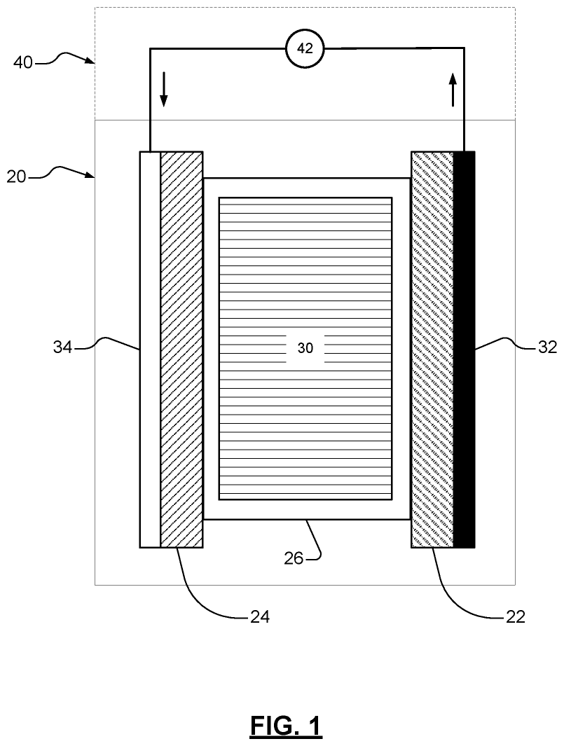

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include (additionally or alternatively) a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S-P₂S₅, Li₆PS₅Cl, Li₆PS₅Br, Li₆PS₅I, Li₃OCl, Li_{2.99}Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The positive electrode 24 (also referred to as the positive electroactive material layer) is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃MnO₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In still further variations, the positive electrode 24 may be a composite electrode including a combination of positive electroactive materials. For example, the positive electrode 24 may include a first positive electroactive material and a second electroactive material. A ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

In each variation, the positive electroactive material may be optionally intermingled (e.g., slurry casted) with an electronically conductive material (i.e., conductive additive) that provide an electron conductive path and/or a polymeric binder material that improve the structural integrity of the positive electrode 24. For example, the positive electrode 24 may include greater than or equal to about 70 wt. % to less than or equal to about 98 wt. %, and in certain aspects, optionally greater than or equal to about 80 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 (also referred to as a negative electroactive material layer) is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have an average thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, the negative electroactive material includes an atomically layered electroactive (or anode) material, where each crystallographic plane is considered a layer. The atomically layered electroactive material may include silicon (Si), germanium (Ge), and/or boron (B). For example, the negative electroactive material may include a two-dimensional, layered allotrope of silicon (Si), a two-dimensional, layered allotrope of germanium (Ge), and/or a two-dimensional, layered allotrope of boron (B). The two-dimensional, layered allotropes may include planes of atoms strongly bound in-plane and weakly coupled out of plane (i.e., little to no bonding between layers) at an angstrom scale, similar to graphite. For example, the atomically layered anode material may include silicene, a multi-layered silicene, germanene, a multi-layered germanene, borophene, a multilayer borophene, or any combination thereof. The atomically layered electroactive material may form micro-scale and/or nano-scale electroactive material particles, including, for example, electroactive material particles having an average diameter greater than or equal to about 100 nm to less than or equal to about 50 μm.

Such atomically layered electroactive materials may exhibit improved cyclability, for example, the layered electroactive materials may have an intrinsic capacity of about 2,000 mAh/g at about 100 mA/g current. The layered electroactive materials may have an intrinsic capacity of 2,000 mAh/g at 100 mA/g current. The layered structure may serve to relieve internal stresses that arise during lithiation and enhance ionic diffusion within the negative electrode 22. For example, the two-dimensional structure may allow lithium ions to intercalate between the layers via pseudo Van der Waals gaps, to store lithium ions without destroying the lattice structure thereby helping to avoid pulverization or decrepitation of the structure (similar to intercalation of lithium in graphite). Additionally, the two-dimensional channels formed between layers may better facilitate ionic diffusion to permit faster charge rates.

In various aspects, the atomically layered electroactive materials may include one or more other (or interplanar) atoms disposed between and binding the atomic planes. The interplanar binding supplements the Van der Waals forces and help to enhance the interlayer integrity of the layered electroactive material and also the electrical conductivity of the layered electroactive material, for example, by further limiting volume expansion and also limiting cleavage or exfoliation of the atomic planes and maintaining electronic contact. The interplanar binding may also allow for further polymorphic control of the electroactive material particles (for example, by controlling an amount of cations remaining (or left) in the electroactive material, as further detailed below). In certain variations, the one or more other atoms may include divalent cations like calcium (Ca), magnesium (Mg), zinc (Zn), copper (Cu), and/or nickel (Ni) atoms. In other variations, the one or more other atoms may include monovalent cations like potassium (K) and/or sodium (Na). For example, in various aspects, the one or more other atoms may be selected from the group consisting of: calcium, magnesium, zinc, copper, nickel, potassium, sodium, and combinations thereof. In various aspects, a ratio of the cations to atoms defining the atomic layer may be less than 1:2. For example, the atomically layered electroactive materials may be represented by the atomic formula X¹_{(1-y)}X²₂, where X¹ is selected from calcium, magnesium, zinc, copper, nickel, potassium, and/or sodium, X² is selected from silicon, germanium, and/or boron, and y is less than 1. For example, when a precursor material includes CaSi₂, the atomically layered electroactive materials may be represented by Ca₍₁₋ₓ₎Si₂ where 0<x<1.

In certain variation, the atomically layered electroactive materials including interplanar atoms may be pre-lithiated. For example, lithium ions (Li⁺) may be introduced between the atomic layers of the two-dimensional structure. The electroactive materials may be pre-lithiated prior to or after incorporating into the negative electrode 22 and/or the battery 20. For example, in certain variations, the electroactive materials may be prelithiated using methods like those detailed in U.S. application Ser. No. 17/840,928, titled “Methods for Fabricating Pre-Lithiated, Two-Dimensional Anode Materials,” filed Jun. 15, 2022 and naming Yuntao Gu, Jeffrey David Cain, Sayed Youssef Sayed Nagy, Nicholas Paul William Pieczonka, and Thomas E. Moylan as inventors; and in U.S. application Ser. No. 17/335,972, titled “Electrochemical Exchange for the Fabrication of a Layered Anode Material,” filed Jun. 1, 2021 and naming Jeffery David Cain, Thomas E. Moylan, Leng Mao, Paul Taichiang, Nicholas Paul William Pieczonka, and Andrew Clay Bobel as inventors, the entire disclosures of which are hereby incorporated by reference. The pre-lithiation of the electroactive materials may help to compensation for lithium loses during cycling such as may result during conversion reactions and/or the formation of LixSi and/or a solid electrolyte interphase (SEI) layer (not shown) on the negative electrode 22 during the first cycle, as well as ongoing lithium loss due to, for example, continuous solid electrolyte interphase (SEI) formation.

In certain variations, negative electrode 22 may be a composite electrode including a combination of negative electroactive materials. For example, the negative electrode 22 may include a first negative electroactive material and a second negative electroactive material. A ratio of the first negative electroactive material to the second negative electroactive material may be greater than or equal to about 5:95 to less than or equal to about 95:5. In certain variations, the first negative electroactive material may be a two-dimensional layered electroactive material, and the second negative electroactive material may include, for example, a three-dimensional layered electroactive material. In other variations, the first negative electroactive material may be a two-dimensional layered electroactive material, and the second negative electroactive material may include, for example, a carbonaceous material (e.g., graphite, graphene, hard carbon, soft carbon, and the like). The atomically layered electroactive material of the first negative electroactive material may include interplanar atoms, like calcium, magnesium, zinc, copper, nickel, potassium, and/or sodium.

In each variation, the negative electroactive material may be optionally intermingled with an electronically conductive material (i.e. conductive additive) that provides an electron conductive path and/or a polymeric binder material that improves the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or binder material as included in the negative electrode 22 may be the same as or different from the conductive additive as included in the positive electrode 24.

In various aspects, the present disclosure provides methods for making layered electroactive materials including interplanar atoms for use in negative electrodes, like the negative electrode 22 illustrated in FIG. 1. For example, one example method may include partially removing cations from a precursor material. Another example method may include fully removing cations from a precursor material and a partial intercalation of selected cations. Yet another example method may include an ion exchange process followed by partial de-intercalation.

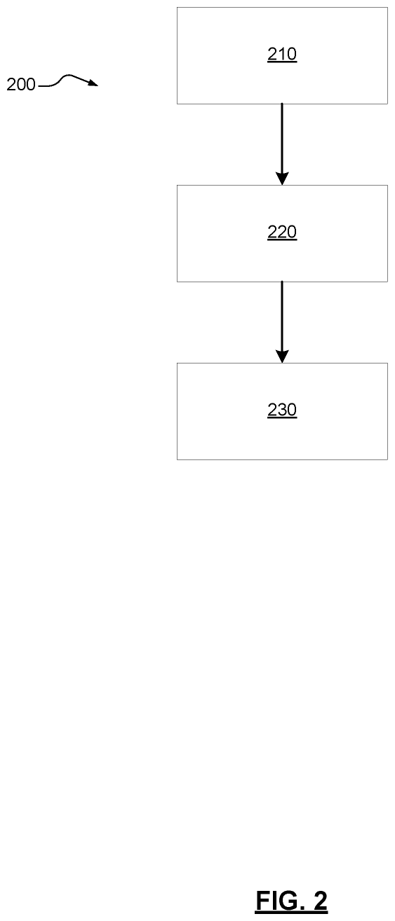

FIG. 2 illustrates an example method 200 for preparing a layered electroactive material including interplanar atoms, where the method 200 is a de-intercalation process that includes partially removing 220 cations from a precursor material. The precursor material may include an ionic/atomic species represented by M¹ₓM²₂, where M¹ is selected from calcium, magnesium, zinc, copper, nickel, potassium, and/or sodium, M² is selected from silicon, germanium, and/or boron, and x is less than 1. In each instance, the precursor material includes alternating layers, such that the cations (e.g., Ca²⁺) are amenable to electrochemical extraction. For example, the precursor material may include CaSi₂, which is a compound including alternating atomic layers of silicon and calcium. When the cations (e.g., Ca²⁺) are removed, a two-dimensional, layered crystal remains, and the residual cations are interplanar atoms. The partial removal 220 of cations (e.g., Ca²⁺) form the precursor material may include removing less than or equal to about 50%, and in certain aspects, less than or equal to about 95%, of the available cations from the precursor material. The method 200 may also include preparing 210 the precursor material and/or incorporating 230 the as-formed electroactive material (with or without a current collector (e.g., 332)) in an electrode and/or electrochemical cell. Further, although not illustrated, in certain variations, the method 200 may also include one or more steps for prelithiation the as-formed electroactive material, as discussed above.

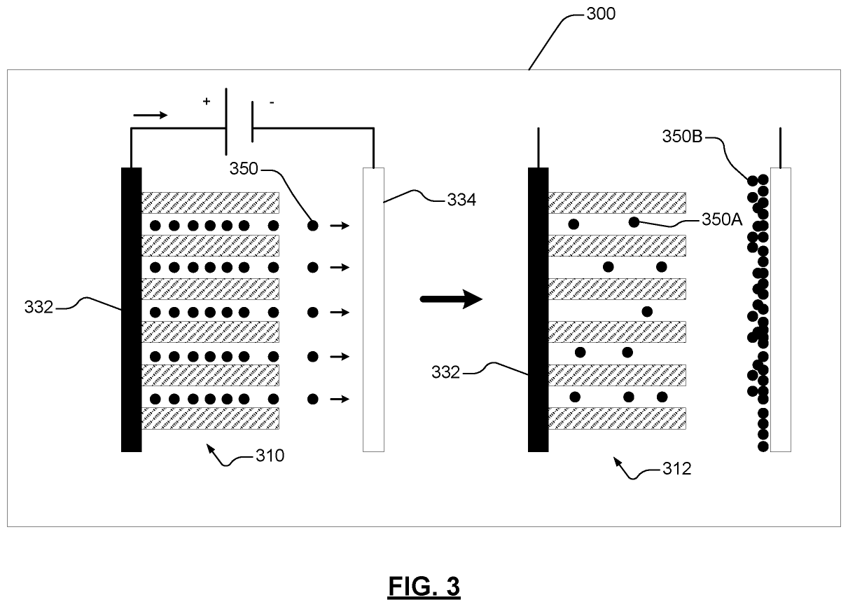

In certain variations, the cations may be partially removed 220 using electrochemical processes, like the electrochemical processes detailed in U.S. application Ser. No. 17/335,972, titled “Electrochemical Exchange for the Fabrication of a Layered Anode Material,” filed Jun. 1, 2021 and naming Jeffery David Cain, Thomas E. Moylan, Leng Mao, Paul Taichiang, Nicholas Paul William Pieczonka, and Andrew Clay Bobel as inventors, the entire disclosure of which is hereby incorporated by reference. For example, the electrochemical process 300 in accordance with various aspects of the present disclosure may include applying a bias and/or current to a precursor assembly to induce movement of cations away from the precursor assembly to form a layered electroactive material including interplanar atoms 312. For example, as illustrated in FIG. 3, a precursor material 310 may be disposed on or near a surface of a first current collector 332. The first current collector 332 may be a negative current collector similar to the negative current collector 32 illustrated in FIG. 1. The first current collector 332 may be aligned with a second current collector 334. The second current collector 334 may be a positive current collector similar to the positive current collector 34 illustrated in FIG. 1. As illustrated in FIG. 3, a bias (i.e., voltage) and/or current may be applied so as to induce movement of a portion of the cations 350B from the precursor material 310 to the second current collector 334 leaving behind (i.e., creating) a two-dimensional, layered anode material 312 having some interplanar cations 350A on or near to the first current collector 332.

In certain variations, the electrochemical process 300 may include a batch process that includes, for example, placing the precursor assembly inside an electronically conductive liquid permeable cage and disposing the electronically conductive liquid permeable cage in an electrolyte bath (including an electrolyte like the electrolyte 30 illustrated in FIG. 1) prior to application of the bias and/or current. The electronically conductive, liquid permeable cage may be configured to retain or hold the precursor material 310 while allowing cations to flow or move into and out of the electronically conductive, liquid permeable cage. In other variations, the electrochemical process 300 may include a continuous process that includes, for example, moving the precursor assembly through an electrolyte bath (including an electrolyte like the electrolyte 30 illustrated in FIG. 1) as the bias and/or current are applied using a roll-to-roll configuration. In each instance, to retain a portion of the interplanar cations 350A the electrochemical process 300 may include discharging to a pre-selected voltage or alternatively for a pre-selected period of time at a pre-selected current. For example, in certain variations, such as when the precursor material 310 includes CaSi₂, the cations (e.g., Ca²⁺) can be discharged from the structure at about 0.5 A/g for about 1 hour and about 90% of the available cations would be extracted.

With renewed reference to FIG. 2, in other variations, the cations may be partially removed 220 using chemical extraction processes. For example, in certain variations, the precursor material can be exposed to concentrated hydrochloric acid. A reactant ratio may be limited to a pre-selected stoichiometry to retain a select portion of the interplanar cations. For example, when the precursor material includes CaSi₂, one cation (e.g., Ca²⁺) can be removed for every two available chloride (e.g., Cl⁻), as represented by the following equation: CaSi₂+HCl·H₂+CaCl₂). The number of available chlorines in solution can be selected so that a specific amount of cations (e.g., Ca²⁺) remain in the electroactive material structure.

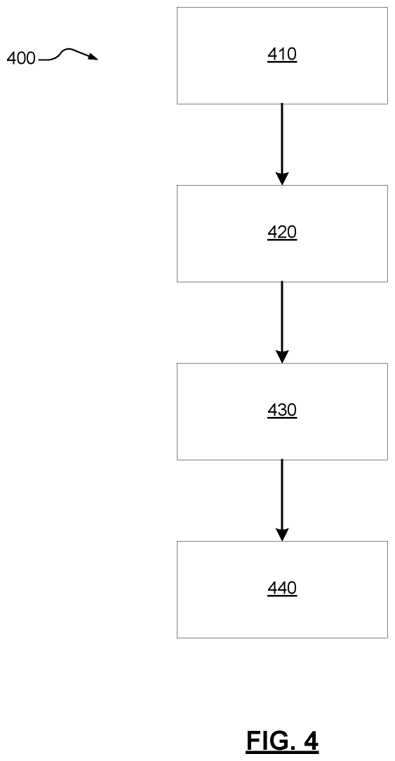

FIG. 4 illustrates an example method 400 for preparing a layered electroactive material including interplanar atoms, where the method 400 includes removing 420 all of a first cation species form a precursor material and partially intercalating 430 another cation species into the interplane (or interlayer) space. As in the above detailed example, the precursor material may include an ionic/atomic species represented by M¹ₓM²₂, where M¹ is selected from calcium, magnesium, zinc, copper, nickel, potassium, and/or sodium, M² is selected from silicon, germanium, and/or boron, and x is less than 1. Unlike the above method 200 as illustrated in FIG. 2, the method 400 as illustrated in FIG. 4 removes substantially all (e.g., less than 5 at. % of the first cation species may remain) of the first cation species form the precursor material to form a layered electroactive material and partially introducing (or intercalating) 430 the second cation species to form a layered electroactive material including interplanar atoms. The introduction 430 of the second cation species is “partial” because the exchange of the first cation species for the second cation species is not a one-to-one exchange, rather the layered electroactive material formed by the removal of the first cation species is only partially impregnated (e.g., 50% to about 90%) with the second cation species. The first and second cation species may be independently selected from calcium, magnesium, zinc, copper, nickel, potassium, and/or sodium.

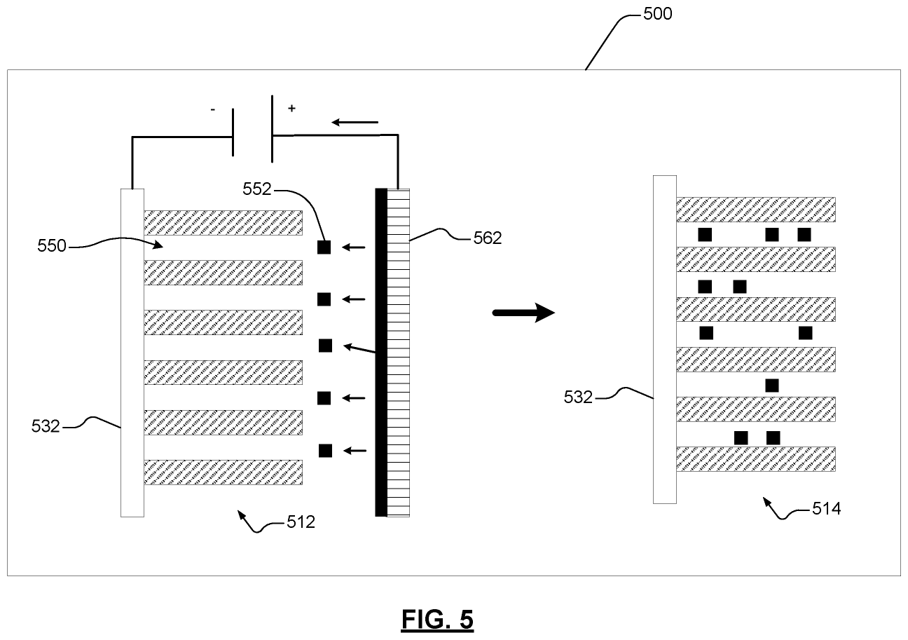

In certain variations, the first cation species may be removed 420 using an acid etching process and/or a chemical extraction processes and/or an electrochemical extraction, as detailed above in the context of method 200 as illustrated in FIG. 2. In certain variations, the second cation species may be intercalated 430 into the interplanar space using an electrochemical intercalation process. The electrochemical intercalation process may include electrochemical exchange processes, like the electrochemical exchange processes detailed in U.S. application Ser. No. 17/335,972, titled “Electrochemical Exchange for the Fabrication of a Layered Anode Material,” filed Jun. 1, 2021 and naming Jeffery David Cain, Thomas E. Moylan, Leng Mao, Paul Taichiang, Nicholas Paul William Pieczonka, and Andrew Clay Bobel as inventors, the entire disclosure of which is hereby incorporated by reference. For example, the electrochemical process 500 in accordance with various aspects of the present disclosure, and similar to electrochemical process 300 for the removal of cations as detailed above, may include applying a bias and/or current to the as-formed layered electroactive material 512 to induce movement of the secondary cations towards the layered electroactive material to form a layered electroactive material including interplanar atoms 514. For example, as illustrated in FIG. 5, the as-formed layered electroactive material 512 may be disposed on or near a surface of a first current collector 532. The first current collector 532 may be a negative current collector similar to the negative current collector 32 illustrated in FIG. 1. The first current collector 532 may be aligned with a second current collector 562. The second current collector 562 may be a positive current collector similar to the positive current collector 34 illustrated in FIG. 1. The secondary cations 552 may be disposed on one or more surfaces of the second current collector 562. As illustrated in FIG. 5, a bias (i.e., voltage) and/or current may be applied so as to induce movement of secondary cations 552 towards the layered electroactive material 512 to form the layered electroactive material including interplanar atoms 514. As illustrated, the secondary cations 552 may move into interlayer spaces or voids 550 created by the removal of the first cations. Like in the instance of the electrochemical process 300, the electrochemical process 500 may include a batch process and/or a continuous process.

With renewed reference to FIG. 4, In certain variations, the method 400 may also include preparing 410 the precursor material and/or incorporating 440 the as-formed electroactive material (with or without a current collector) in an electrode and/or electrochemical cell. Further, although not illustrated, in certain variations, the method 400 may also include one or more steps for prelithiation the as-formed electroactive material, as discussed above.

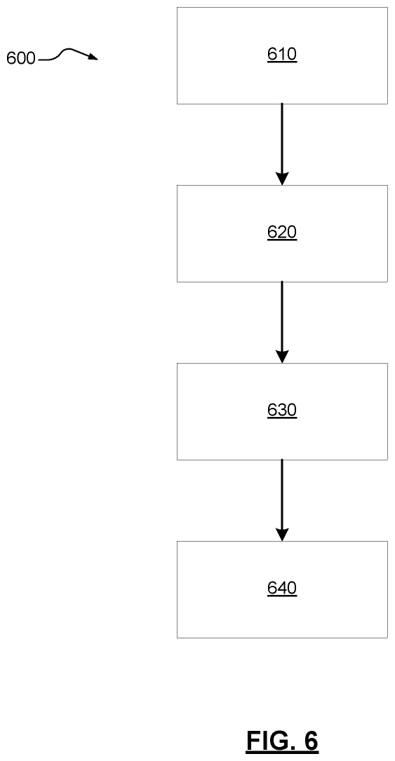

FIG. 6 illustrates an example method 600 for preparing a layered electroactive material including interplanar atoms, where the method 600 includes subjecting a precursor material to an ion exchange process 620 to form a modified precursor material and partially removing (i.e., de-intercalation) 630 secondary cations from the modified precursor material. As in the above detailed example, the precursor material may include an ionic/atomic species represented by M¹ₓM₂², where M¹ is selected from calcium, magnesium, zinc, copper, nickel, potassium, and/or sodium, M² is selected from silicon, germanium, and/or boron, and x is less than 1. Unlike the above method 200 illustrated in FIG. 2, however, the process includes an ion exchange process 620 prior to the partial de-intercalation 630. In certain variations, the ion exchange process 620 may include reacting the precursor material with metal chlorides (e.g., NiCl₂, MgCl₂, and the like) in a solid-state reaction to substitute cations. In certain variations, the cations may be partially removed 630 form the modified precursor material using chemical extraction processes and/or electrochemical processes, like the electrochemical processes 300 illustrated in FIG. 3. The partial removal 630 of cations from the modified precursor material may include removing less than or equal to about 50%, and in certain aspects, less than or equal to about 95%, of the available cations from the modified precursor material. Selecting the combination of cations may help to provide stronger interplanar interactions and/or electronic conductivities. In various aspects, the method 600 may also include preparing 610 the precursor material and/or incorporating 650 the as-formed electroactive material (with or without a current collector) in an electrode and/or electrochemical cell. Further, although not illustrated, in certain variations, the method 200 may also include one or more steps for prelithiation the as-formed electroactive material, as discussed above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electroactive material for an electrochemical cell that cycles lithium ions, the electroactive material comprising:
a plurality of atomic layers and a plurality of cations disposed between the atomic layers, wherein the plurality of atomic layers comprise an atom selected from the group consisting of: silicon, germanium, boron, and combinations thereof, and a ratio of the cations to atoms that define the atomic layer is less than about 1:2.

2. The electroactive material of claim 1, wherein the electroactive material is represented by X¹_{(1-y)}X²₂, where X¹ represents the cation, X² represents the atom that defines the atomic layers, and y is less than 1.

3. The electroactive material of claim 1, wherein the plurality of cations is selected from the group consisting of: calcium, magnesium, zinc, copper, nickel, potassium, sodium, and combinations thereof.

4. The electroactive material of claim 3, wherein the plurality of cations is a first plurality of cations, and the electroactive material further comprises a second plurality of cations, the second plurality of cations comprising lithium ions.

5. The electroactive material of claim 1, wherein the plurality of cations is a first plurality of cations, and the electroactive material further comprises a second plurality of cations, the first plurality of cations comprising calcium, and the second plurality of cations selected from the group consisting of: magnesium, zinc, copper, nickel, potassium, sodium, and combinations thereof.

6. The electroactive material of claim 1, wherein the electroactive material is in the form of a plurality of electroactive particles having an average diameter greater than or equal to about 100 nanometers to less than or equal to about 50 micrometers.

7. A method for forming a layered negative electrode material, the method comprising:
removing cations from a precursor material to form the layered negative electrode material comprising a plurality of atomic layers comprising atoms and having ions disposed between the atomic layers, wherein a ratio of the ions to atoms defining the atomic layer is less than 1:2.

8. The method of claim 7, wherein the cations in the precursor material comprise a first portion of cations and a second portion of cations and the removing of the cations removes the first portion of the cations, wherein the second portion remaining in the precursor material defines the ions.

9. The method of claim 8, wherein the removing of the cations comprises an electrochemical extraction process or a chemical extraction process.

10. The method of claim 7, wherein the precursor material is represented by M¹ₓM²₂, where M¹ is selected from the group consisting of: calcium, magnesium, zinc, copper, nickel, potassium, sodium, and combinations thereof, M² is selected from the group consisting of: silicon, germanium, boron, and combinations thereof, and x is less than 1.

11. The method of claim 7, wherein the removing of the cations comprises removing substantially all of the cations in the precursor material, and the method further comprises:
re-intercalating secondary cations to form the ions disposed between the plurality of atomic layers.

12. The method of claim 11, wherein the precursor material comprises CaX₂, where X is selected from the group consisting of: silicon, germanium, boron, and combinations thereof, and the secondary cations are selected from the group consisting of: magnesium, zinc, copper, nickel, potassium, sodium, and combinations thereof.

13. The method of claim 11, wherein the re-intercalating comprises a chemical process or electrochemical process.

14. The method of claim 7, wherein the removing of the cations from the precursor material comprises exchanging the cations for secondary cations using an ion exchange process to form a modified precursor material comprising a first portion of secondary cations and a second portion of secondary cations, and de-intercalating the first portion of the secondary cations from the modified precursor material, wherein the second portion of the secondary cations defines the ions disposed between the atomic layers.

15. The method of claim 14, wherein the precursor material comprises CaX₂, where X is selected from the group consisting of: silicon, germanium, boron, and combinations thereof, and the secondary cations are selected from the group consisting of: magnesium, zinc, copper, nickel, potassium, sodium, and combinations thereof.

16. The method of claim 14, wherein the de-intercalating of the first portion of the secondary cations comprises an electrochemical extraction process or a chemical extraction process.

17. The method of claim 7, wherein the precursor material is disposed on or near one or more surfaces of a current collector.

18. An electrochemical cell that cycles lithium ions, the electrochemical cell comprising:
a first electrode having a first polarity and comprising a first electroactive material;
a second electrode having a second polarity different from the first polarity and comprising a second electroactive material, the second electroactive material comprising:
a plurality of atomic layers comprising an atom selected from the group consisting of: silicon, germanium, boron, and combinations thereof; and
a plurality of cations disposed between the atomic layers, the plurality of cations selected from the group consisting of: calcium, magnesium, zinc, copper, nickel, potassium, sodium, and combinations thereof,
wherein a ratio of the cations to atoms defining the atomic layer is less than 1:2; and
a separating layer disposed between the first electrode and the second electrode.

19. The electrochemical cell of claim 18, wherein the plurality of cations is a first plurality of cations, and the second electroactive material further comprises a second plurality of cations, the second plurality of cations comprising lithium ions.

20. The electrochemical cell of claim 18, wherein the plurality of cations is a first plurality of cations, and the second electroactive material further comprises a second plurality of cations, the first plurality of cations comprising calcium, and the second plurality of cations comprising ions selected from the group consisting of: magnesium, zinc, copper, nickel, potassium, sodium, and combinations thereof.
